(19) United States
(12) Patent Application Publication
(10) Pub. No.: US 2017/0158994 A1
(43) Pub. Date: Jun. 8, 2017

(54) CLEANING POUCH

(71) Applicant: The Procter & Gamble Company, Cincinnati, OH (US)

(72) Inventors: Nathalie Sophie LETZELTER, Trimdon (GB); Frank HULSKOTTER, Bad Duerkheim (DE); Rohan Govind MURKUNDE, Northumberland (GB); Kevin George GOODALL, Tervuren (BE); Marta REINOSO-GARCIA, Ludwigshafen (DE)

(21) Appl. No.: 15/365,978

(22) Filed: Dec. 1, 2016

(30) Foreign Application Priority Data
Dec. 8, 2015 (EP) 15198502.5

(51) Int. Cl. C11D 17/04; C11D 3/37; B65D 65/46; C11D 11/00; B65B 3/04; B65B 7/02; C11D 3/33; C11D 3/20

(52) U.S. Cl. CPC C11D 17/045; C11D 17/043; C11D 3/33; C11D 3/3765; C11D 3/2079; C11D 11/0023; B65B 3/04; B65B 7/02; B65D 65/46

(57) ABSTRACT

A single or multi-phase water-soluble cleaning pouch comprising a cleaning composition and an enveloping material, the pouch comprises at least one compartment comprising an aqueous composition, the aqueous composition comprising (i) in the range of from 45 percent by weight to 60 percent by weight based on the total weight of the aqueous composition of at least one complexing agent (A) selected from the group consisting of methylglycine diacetic acid, glutamic acid diacetic acid, their salts and mixtures thereof; (ii) in the range of from 1 percent by weight to 30 percent by weight based on the weight of component (A) of at least one homo- or copolymer of (meth)acrylic acid (B) that is either partially or fully neutralized, and (iii) water.

### TECHNICAL FIELD

The present invention is in the field of cleaning. It relates to a cleaning product, in particular a cleaning product in the form of a water-soluble pouch, more in particular the pouch comprises an aqueous composition comprising a complexing agent and a homo- or copolymer of (meth)acrylic acid.

### BACKGROUND OF THE INVENTION

Unit-dose detergents have become widely spread lately. As the name indicates, unit-dose detergents are pouches containing a single dose of detergent. A common form of unit-dose detergent nowadays corresponds to detergent compositions enclosed by a water-soluble enveloping material. This obviates the need to unwrap. The formulation of detergents to be enclosed by water-soluble material continues to be a challenge. This is most so in cases in which phosphate needs to be replaced. Phosphate is not only an excellent cleaning active but also contributes to processability and product stability by adsorbing moisture from the surrounding environment and/or from the product itself.

Aminocarboxylate complexing agents can be used to replace phosphate in its cleaning capacity, however, these materials are not easy to formulate with. Aminocarboxylate complexing agents are usually synthesized in liquid form. They can be further processed into solid particles or granules. Aminocarboxylate complexing agents synthesized in liquid form, such as methyl glycine diacetic acid (MGDA), have a high level of solvent associated to them. This makes them inconvenient in terms of transport (high volume of the liquid is needed in order to get not too high level of active). This high level of solvent is also a problem when the complexing agent needs to be formulated as part of a detergent in the form a unit dose water-soluble pouch. In addition to the volume constrains, in the case of unit dose, the solvent can also bring incompatibility issues with the rest of the active ingredients of the detergent composition and also present negative interactions with the water-soluble film.

Complexing agents such as methyl glycine diacetic acid (MGDA) and glutamic acid diacetic acid (GLDA) and their respective salts are useful sequestrants for alkaline earth metal ions such as Ca2+ and Mg2+. For that reason, they are recommended and used for various purposes such as laundry detergents and for automatic dishwashing (ADW) formulations, in particular for so-called phosphate-free laundry detergents and phosphate-free ADW formulations. For shipping such complexing agents, in most cases either solids such as granules are being applied or aqueous solutions.

Detergent formulators wish to obtain complexing agents in aqueous solutions that are as concentrated as possible. The lower the concentration of the requested complexing agent the more space is taken and less space is available for cleaning actives.

Although about 40% by weight solutions of MGDA and even 45% by weight solutions of GLDA can be made and stored at room temperature, local or temporary colder conditions may lead to precipitation of the respective complexing agent, as well as nucleating by impurities. Said precipitations may lead to chemical instability and/or negative impact on the enveloping material properties.

Additives that may enhance the solubility of the respective complexing agents may be considered but such additives should not negatively affect the properties of the respective complexing agent.

It is therefore the objective of the present invention to provide a water-soluble cleaning pouch comprising a highly concentrated solution of complexing agents such as MGDA or GLDA that are stable at temperatures in the range from zero to 50° C. It is a further objective of the present invention to provide a method for manufacture of highly concentrated aqueous solutions of complexing agents such as MGDA or GLDA that are stable at temperatures in the range from zero to 50° C. Neither such method nor such aqueous solution should require the use of additives that negatively affect the cleaning properties of the respective complexing agent.

Other considerations when designing a liquid containing water-soluble pack is the viscosity of the product. Liquids to be packed in water-soluble films should be not too thin otherwise they will splash while being delivered into the pouch negatively impacting on the seal or not too thick. Thick liquids would delay dissolution and would increase the duration of the filling step thereby increasing the processing time.

The objective of the invention is to provide a unit dose water-soluble pouch that overcomes the above mentioned issues.

### SUMMARY OF THE INVENTION

The present invention provides a water-soluble cleaning pouch, i.e. a pouch containing a cleaning composition. The pouch can have a single or a plurality of compartments, preferably the pouch comprises a plurality of compartments. At least one compartment comprises an aqueous composition. The aqueous composition comprises
(i) in the range of from 45 to 60% by weight of a complexing agent (A), selected from the group consisting of methylglycine diacetic acid, glutamic acid diacetic acid, their salts and mixtures thereof,
(ii) in the range of from 1 percent by weight to 30 percent by weight based on the weight of component (A) of at least one homo- or copolymer of (meth)acrylic acid (B) that is either partially or fully neutralized, and
(iii) water.

The composition of the pouch of the invention is preferably liquid. By “aqueous” is herein meant that the composition comprises about 10% or more, preferably about 15% or more, more preferably about 20% or more and especially about 30% or more and about 60% or less preferably 50% or less of water by weight of the composition.

By “warm water soluble material” is meant a material that takes more than 3 minutes, preferably more than 4 minutes and specially more than or equal to about 5 minutes to dissolve at 20° C., according the method described hereinbelow.

In contrast, by “cold water soluble material” is meant a material that takes 3 minutes or less, preferably less than 2 minutes and specially less than or equal to about 1 minute to dissolve at 20° C., according the method described herein below.

As stated herein above the warm water soluble material is preferably a warm water soluble film. Preferably the warm water soluble material is a film comprising polyvinyl acetate with a degree of hydrolysis of from about 90 to about 99%, preferably from about 92 to about 98% and more preferably from about 94 to about 98%.

The equilibrium relative humidity (eRH) of the composition of the invention can be further improved by the addition of an eRH reducing agent. A preferred eRH reducing agent for use herein is a salt of an organic acid preferably the acid is selected from the group consisting of mono, di-carboxylic acids and mixtures thereof, more preferably the acid is selected from mono-carboxylic acids, especially the acid is selected from formic acid, acetic acid and mixtures thereof. Preferably, the salts are metal salts and more preferably alkali metal salts, potassium being specially preferred. Potassium formate has been found the most efficient salt in terms of eRH reduction.

Preferably, the complexing agent and the salt of the organic acid are in a weight ratio of at least 2:1, more preferably from 3:1 to 10:1.

Aqueous compositions having a pH of from about 10 to about 11, preferably from about 10.5 to about 11, as measured as a 1% aqueous solution at 22° C. have been found to have good compatibility with the enveloping material in particular when the enveloping material is a polyvinyl alcohol film. Compositions outside this pH range can lead to the formation of residues on the outer surface of the enveloping material, making the film opaque or the composition can weep through the enveloping material, depending on the conditions of the surrounding environment.

In some instances it is desirable to have aqueous compositions with low viscosity. Low viscosity compositions can be delivered into the pouch at higher speed than compositions of higher viscosity. Preferred viscosities for the composition of the invention are in the range of from about 200 to about 800, more preferably from about 350 to about 550 mPa s determined according to DIN 53018-1:2008-09 at 23° C.

In a preferred embodiment the aqueous composition comprises:

from about 45 to about 55% by weight thereof of the complexing agent selected from the group consisting of methylglycine diacetic acid, its salts and mixtures thereof,
from about 2.5 percent by weight to 20 percent by weight based on the weight of component (A) of at least one homo- or copolymer of (meth)acrylic acid (B) that is either partially or fully neutralized, and water.

It has been found that the stability of the pouch is improved when the enveloping material comprises polyvinyl alcohol and a plasticiser and the aqueous composition preferably comprises the same plasticiser as the film.

A preferred pouch herein is a multi-compartment pouch comprising a second compartment containing a second composition comprising a moisture sensitive ingredient wherein the moisture sensitive ingredient is preferably selected from the group consisting of bleach, enzymes and mixtures thereof. The stability properties of the aqueous composition of the invention contribute to the total stability of the pouch.

Preferably, the aqueous composition has an equilibrium relative humidity (eRH) of less than about 65%, preferably more than about 20% and less than about 60%, more preferably more than about 30% and less than about 55% at 20° C. as measured as detailed herein below. A low relative humidity is desirable for some detergent compositions, in particular when the composition comprises moisture sensitive ingredients such as bleach, enzymes, etc. Incompatibilities can occur when the moisture sensitive ingredients are in the compartment containing the aqueous composition or in a separate compartment, due to moisture migration through the enveloping material. The low eRH of the aqueous composition also helps to preserve the physical and mechanical properties of the enveloping material and avoids premature dissolution and weakening of the enveloping material.

### DETAILED DESCRIPTION OF THE INVENTION

The present invention envisages a water-soluble cleaning pouch comprising at least one compartment comprising an aqueous composition said aqueous composition comprising a complexing agent and a homo- or copolymer of (meth)acrylic acid. The pouch provides very good cleaning and at the same time presents good stability. The complexing agent is preferably selected from methyl glycine diacetic acid (MGDA), glutamic acid diacetic acid (GLDA), their salts and mixtures thereof. Especially preferred salts for use herein are the trisodium salt of MGDA and the tetrasodium salt of GLDA. Mixtures of MGDA and GLDA are also preferred for use herein.

### Water Soluble Pouch

A water-soluble cleaning pouch is a pouch containing a cleaning composition, preferably an automatic dishwashing or laundry detergent composition, and an enveloping material. The enveloping material is water-soluble and preferably a water-soluble film. Both the cleaning composition and the enveloping material are water-soluble. They readily dissolve when exposed to water in an automatic dishwashing or laundry process, preferably during the main wash. The pouch can have a single compartment or a plurality of compartments (multi-compartment pouch). One of the compartments of the pouch comprises a liquid composition, this liquid composition can be part or the total cleaning composition. In the case of multi-compartment pouches, the liquid composition would be a part of the total cleaning composition.

By “multi-compartment pouch” is herein meant a pouch having at least two compartments, preferably at least three compartments, each compartment contains a composition surrounded by enveloping material. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit, pouch aging optimisation and enveloping material reduction are multi-compartment pouches having some superposed compartments and some side-by-side compartments.

### Warm-Water Soluble Enveloping Material

The warm water soluble material is slow dissolving in cold water. Preferred for use herein are commercially available polyvinyl alcohols (PVA) obtained by hydrolysis of polyvinyl acetates. The solubility of these films can be selectively adjusted by the degree of hydrolysis of the PVA or by using a cross-linking agent. Preferably, the film comprises polyvinyl acetate with a degree of hydrolysis of from about 90 to about 99%, preferably from about 92 to about 98% and more preferably from about 94 to about 98%. The degree of hydrolysis is expressed as a percentage of vinyl acetate units converted to vinyl alcohol units.

Examples of commercially available PVA suitable for use herein are BP26 available from Aicello, L10 and L15 available from Aquafilm, VF-M and VM-S available from Kuraray and E-2060 available from Monosol, especially preferred for use herein is BP26 available from Aicello. The thickness of the material can influence the dissolution kinetics, films having a thickness between about 1 and about 200, more preferably between 10 and 100 μm are preferred for use herein.

Other preferred materials for use herein are starch, starch derivatives, cellulose and cellulose derivatives, more especially methyl cellulose and mixture thereof. Especially preferred for use herein are polymers comprising hydroxypropylmethylcellulose.

The cleaning composition is preferably an automatic dishwashing composition. The composition is preferably phosphate free.

### Aqueous Composition

Preferably, the aqueous composition is liquid and comprises about 10% or more, preferably about 15% or more, more preferably about 20% or more of water by weight of the liquid composition. Preferably the liquid composition comprises about 56% or less, more preferably about 40% or less of water by weight of the liquid composition.

The level of the complexing agent in the cleaning composition is preferably from about 5 to about 30%, more preferably from about 10% to about 20% by weight of the cleaning composition.

For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 5, preferably at least 6. The stability constant, log K is measured in a solution of ionic strength of 0.1, at a temperature of 25° C.

Complexing agent (A) is selected from methylglycine diacetic acid and its salts, preferably mono-, di-, or trialkali metal and mono-, di- or triammonium salts, and glutamic acid diacetic acid and its salts, preferably mono-, di-, tri- or tetraalkali metal and mono-, di-, tri- or tetraammonium salts.

Salts of methylglycine diacetic acid are preferably selected from lithium salts, potassium salts and more preferably sodium salts of methylglycine diacetic acid. Methylglycine diacetic acid can be partially or preferably fully neutralized with the respective alkali. In a preferred embodiment, an average of from 2.7 to 3 COOH groups of MGDA is neutralized with alkali metal, preferably with sodium. The trisodium salt of MGDA is particularly preferred.

Likewise, alkali metal salts of glutamic acid diacetic acid are preferably selected from lithium salts, potassium salts and more preferably sodium salts of glutamic acid diacetic acid. Glutamic acid diacetic acid can be partially or preferably fully neutralized with the respective alkali. Preferably, an average of from 3.5 to 4 COOH groups of GLDA is neutralized with alkali metal, preferably with sodium. In a particularly preferred embodiment, complexing agent (A) is the tetrasodium salt of GLDA.

Complexing agent (A) is at least partially neutralized with alkali metal, more preferably with sodium or potassium, most preferred with sodium.

Complexing agent (A) can be selected from racemic mixtures of alkali metal salts of MGDA and of GLDA, and of the pure enantiomers such as alkali metal salts of L-MGDA, alkali metal salts of L-GLDA, alkali metal salts of D-MGDA and alkali metal salts of D-GLDA, and of enantiomerically enriched mixtures of isomers.

Preferably complexing agent (A) is selected from mixtures of L- and D-enantiomers of methyl glycine diacetic acid (MGDA) or its respective mono-, di- or trialkali metal or mono-, di- and triammonium salt or mixtures thereof and L- and D-enantiomers of glutamic acid diacetic acid (GLDA) or its respective mono-, di-, tri-, or tetraalkali metal or mono-, di-, tri- or tetraammonium salt or mixtures thereof, said mixtures containing predominantly the respective L-isomer with an enantiomeric excess (ee) in the range of from 10 to 95%.

Preferably the complexing agent (A) is essentially L-glutamic acid diacetic acid that is at least partially neutralized with alkali metal.

Aqueous compositions according to the invention contain in the range of from 45 to 60% by weight of complexing agent (A), preferably 45 to 55% by weight and even more preferably 47 to 52% by weight of the composition. Also preferred are aqueous compositions according to the invention containg in the range of from 49 to 51% by weight of complexing agent (A).

In one embodiment of the present invention, aqueous compositions according to the invention contain in the range of from 45 to 60% by weight alkali metal salt of of methylglycine diacetic acid of complexing agent (A), preferably 45 to 55% by weight and even more preferably 47 to 52% by weight. In another very preferred embodiment, aqueous solutions according to the invention contain in the range of from 49 to 51% by weight alkali metal salt of of methylglycine diacetic acid of complexing agent (A).

In one embodiment of the present invention, aqueous compositions according to the invention contain in the range of from 45 to 60% by weight alkali metal salt of GLDA as complexing agent (A), preferably 45 to 55% by weight and even more preferably 47 to 52 by weight, most preferably 49 to 51% by weight alkali metal salt of GLDA as complexing agent (A).

Minor amounts of complexing agent (A) may bear a cation other than alkali metal. It is thus possible that minor amounts, such as 0.01 to 5 mol-% of total complexing agent (A) bear alkali earth metal cations such as Mg2+ or Ca2+, or an Fe(II) or Fe(III) cation. Complexing agent (A) may contain minor amounts of impurities stemming from its synthesis, such as lactic acid, alanine, propionic acid or the like. “Minor amounts” in this context refer to a total of 0.1 to 1% by weight, referring to complexing agent (A).

Aqueous compositions comprising a mixture of complexing agents present both very good cleaning properties and very good stability. Mixtures of sodium salts of MGDA and GLDA are preferred. Preferably, the mixture comprises more than about 10%, preferably more than about 20%, even more preferably more than 40% of the MGDA salt by weight of the mixture. Preferably, the MGDA and GLDA are in a weight ratio of from 5:1 to 1:10, more preferably from 2:1 to 1:4.

Mixtures of MGDA and GLDA can have a range of viscosities. Aqueous solutions of MGDA have low viscosity. In many operations a higher viscosity is desirable, e.g., in order to avoid splashing of such solutions during processing. On the other hand, highly concentrated aqueous solutions of GLDA at ambient temperature can have high viscosity. Mixtures of complexing agents can be designed to have a predetermined viscosity.

Aqueous compositions according to the invention further comprise a polymer, hereinafter also being referred to as polymer (B), the amount is in the range of from 1 percent by weight to 30 percent by weight, preferably 2.5 percent by weight to 20 percent by weight, most preferred 5 percent by weight to 15 percent by weight based on the weight of component (A).

Polymer (B) is selected from homopolymers (B) of (meth)acrylic acid and of copolymers (B) of (meth)acrylic acid, preferably of acrylic acid, in each case partially or fully neutralized with alkali. In the context of the present invention, copolymers (B) are those in which at least 50 mol-% of the comonomers are (meth)acrylic acid, preferably at least 75 mol-%, even more preferably 80 to 99 mol-%.

Suitable comonomers for copolymers (B) are ethylenically unsaturated compounds, such as styrene, isobutene, ethylene, α-olefins such as propylene, 1-butylene, 1-hexene, and ethylenically unsaturated dicarboxylic acids and their alkali metal salty and anhydrides such as but not limited to maleic acid, fumaric acid, itaconic acid disodium maleate, disodium fumarate, itaconic anhydride, and especially maleic anhydride. Further examples of suitable comonomers are C1-C4-alkyl esters of (meth)acrylic acid, for example methyl acrylate, methyl methacrylate, ethyl acrylate, ethyl methacrylate, n-butyl acrylate.

In one embodiment of the present invention, polymer (B) is selected from copolymers of (meth)acrylic acid and a comonomer bearing at least one sulfonic acid group per molecule. Comonomers bearing at least one sulfonic acid group per molecule may be incorporated into polymer (B) as free acid or least partially neutralized with alkali. Particularly preferred sulfonic-acid-group-containing comonomers are 1-acrylamido-1 propanesulfonic acid, 2-acrylamido-2-propanesulfonic acid, 2-acrylamido-2 methylpropanesulfonic acid (AMPS), 2-methacrylamido-2-methylpropanesulfonic acid, 3 methacrylamido-2-hydroxypropanesulfonic acid, allylsulfonic acid, methallylsulfonic acid, allyloxybenzenesulfonic acid, methallyloxybenzenesulfonic acid, 2-hydroxy-3 (2 propenyloxy)propanesulfonic acid, 2-methyl-2-propene-1-sulfonic acid, styrenesulfonic acid, vinylsulfonic acid, 3-sulfopropyl acrylate, 2 sulfoethyl methacrylate, 3-sulfopropyl methacrylate, sulfomethacrylamide, sulfomethylmethacrylamide, and salts of said acids, such as the sodium salts, potassium salts or ammonium salts thereof.

Copolymers (B) may be selected from random copolymers, alternating copolymers, block copolymers and graft copolymers, alternating copolymers and especially random copolymers being preferred.

Useful copolymers (B) are, for example, random copolymers of acrylic acid and methacrylic acid, random copolymers of acrylic acid and maleic anhydride, ternary random copolymers of acrylic acid, methacrylic acid and maleic anhydride, random or block copolymers of acrylic acid and styrene, random copolymers of acrylic acid and methyl acrylate. More preferred are homopolymers of methacrylic acid. Even more preferred are homopolymers of acrylic acid.

Polymer (B) may constitute straight-chain or branched molecules. Branching in this context will be when at least one repeating unit of such polymer (B) is not part of the main chain but forms a branch or part of a branch. Preferably, polymer (B) is not cross-linked.

Preferably polymer (B) has an average molecular weight Mw in the range of from 1,500 to 15,000 g/mol, more preferably of from 2,000 to 10,000 g/mol, and most preferably of from 2,000 to 5,000 g/mol, determined by gel permeation chromatography (GPC) and referring to the respective free acid.

Preferably, polymer (B) is at least partially neutralized with alkali, for example with lithium or potassium or sodium or combinations of at least two of the forgoing, especially with sodium. Preferably in the range of from 10 to 100 mol-% of the carboxyl groups of polymer (B) are neutralized with alkali, especially with sodium. More preferably 50 to 100 mol-% of of the carboxyl groups of polymer (B) are neutralized with alkali, especially with sodium. Even more preferably 80 to 100 mol-% of of the carboxyl groups of polymer (B) are neutralized with alkali, especially with sodium. Most preferred is a fully neutralized polymer (B).

It is preferred when homo- or copolymer (B) is at least partially neutralized with alkali metal, more preferred fully neutralized with alkali metal, most preferred with sodium, potassium or mixtures of sodium and potassium.

Fully neutralized homo- or copolymer of acrylic acid are especially are preferred for use herein, especially homo- or copolymer neutralized with sodium.

In one embodiment of the present invention, polymer (B) is selected from a combination of at least one polyacrylic acid and at least one copolymer of (meth)acrylic acid and a comonomer bearing at least one sulfonic acid group per molecule, both polymers being fully neutralized with alkali.

Preferably, polymer (B) is selected from per-sodium salts of polyacrylic acid with an average molecular weight Mw in the range of from 1,500 to 15,000 g/mol, more preferably of from 2,000 to 10,000 g/mol, and most preferably of from 2,000 to 5,000 g/mol, determined by gel permeation chromatography (GPC) and referring to the respective free acid.

The aqueous compositions of the invention are very stable. They are stable for more than a week.

To determine the stability of the aqueous compositions, stability is monitored using a daily stability check, for which 200 ml of the composition is placed in a sealed glass and stored at 23° C. and 60% relative humidity. Each day the aqueous composition is controlled optically by observing the samples by eyesight for formation of crystals. The day crystals are observed first is noted and the test ended. The storage stability of the composition is reported as the number of days without crystals observed (i.e. one day less than the duration of the storage stability test).

The aqueous compositions may contain one or more inorganic non-basic salts such as—but not limited to—alkali metal halide or preferably alkali metal sulphate, especially potassium sulphate or even more preferably sodium sulphate. The content of inorganic non-basic salt may be in the range of from 0.10 to 1.5% by weight of the composition. Even more preferably, the aqueous compositions of the invention do not contain significant amounts of inorganic non-basic salt, for example in the range of from 50 ppm to 0.05% by weight of the composition. Even more preferably the aqueous compositions contain 1 to 50 ppm by weight of the composition of the sum of chloride and sulphate. The contents of sulphate may be determined, for example, by gravimetry or by ion chromatography.

The aqueous compositions of the invention can further comprise in the range of from 0.5 to 15% by weight, preferably 1 to 10% by weight, more preferably 2 to 5% by weight of at least one salt of at least one organic acid, hereinafter also referred to as salt (C).

In the context of the present invention, salt (C) is selected from the salts of mono- and dicarboxylic acids. Furthermore, salt (C) is different from both complexing agent (A) and polymer (B).

Preferably, salt (C) either not neutralized or partially neutralized or fully neutralized with alkali metal is selected from the group consisting of acetic acid, formic acid, citric acid, tartaric acid, lactic acid, maleic acid, fumaric acid, malic acid, or mixtures thereof. Preferred salt (C) is selected from the group consisting of citric acid, formic acid, acetic acid, or mixtures thereof. More preferred salt (C) is selected from the group consisting of formic acid, acetic acid, or mixtures thereof. Most preferred salt (C) is formic acid.

The eRH of the aqueous compositions of the invention can be reduced by the addition of an eRH reducing agent. A preferred eRH reducing agent for use herein is a salt of an organic acid preferably the acid is selected from the group consisting of mono, di-carboxylic acids and mixtures thereof, more preferably the acid is selected from mono-carboxylic acids, especially the acid is selected from formic acid, acetic acid and mixtures thereof. Preferably, the salts are metal salts and more preferably alkali metal salts, potassium being specially preferred. Potassium formate has been found the most efficient salt in terms of eRH reduction.

Preferably, the complexing agent and the salt of the organic acid are in a weight ratio of at least 2:1, more preferably from 3:1 to 10:1.

The aqueous composition preferably has an eRH of about 65% or less as measured at 20° C., preferably about 60% or less, more preferably about 55% or less and about 30% or more. The pouch presents a good stability profile (including chemical stability of the cleaning composition and physical and mechanical stabilities of the enveloping material) and at the same time provides good cleaning.

Equilibrium relative humidity “eRH” measures the vapour pressure generated by the moisture present in a composition. It can be expressed as:

eRH=100×Aw
Wherein Aw is water activity:

Aw=p/ps, where:
p: partial pressure of water vapour at the surface of the composition.
ps: saturation pressure, or the partial pressure of water vapour above pure water at the composition temperature.

Water activity reflects the active part of moisture content or the part which, under the established conditions (20° C.), can be exchanged between a composition and its environment. For the purpose of this invention all the measurements are taken at atmospheric pressure unless stated otherwise.

The eRH of the composition can be measured using any commercially available equipment, such as a water activity meter (Rotronic A2101).

Aqueous compositions comprising a salt of an organic acid can present a very good rheological profile. Preferably such compositions have a viscosity in the range of from about 100 to about 800, more preferably from about 200 to about 500 mPa·s, determined according to DIN 53018-1:2008-09 at 23° C. These compositions are very convenient from a processing viewpoint and also from a dissolution viewpoint.

The level of salt of the organic acid in the aqueous composition is preferably from about 0.2% to about 20%, more preferably from about 5% to about 15% by weight of the aqueous composition.

Preferably, the weight ratio of the complexing agent to the salt of the organic acid is at least about 2:1, more preferably at least about 3:1.

### Cleaning Composition

As described herein above the cleaning composition can be formed by partial compositions or each of the compositions of the pouch can be a fully formulated cleaning compositions. In addition to the aqueous composition comprising the mixture of the complexing agent and the homo- or copolymer of (meth)acrylic acid, the pouch preferably comprises a second composition comprising bleach and enzymes, the second composition is preferably in solid form.

Preferably, the cleaning composition of the invention is phosphate free. By “phosphate free” herein is meant that the composition comprises less than 1% by weight thereof of phosphate.

The following actives can be used in the pouch of the invention, in any of the compositions.

### Bleach System

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate is the preferred bleach for use herein. The percarbonate is most preferably incorporated into the products in a coated form which contributes to product stability.

Potassium peroxymonopersulfate is another inorganic perhydrate salt of utility herein. Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 1 to about 20%, more preferably from about 2 to about 15%, even more preferably from about 3 to about 12% and especially from about 4 to about 10% by weight of the composition. Preferably the second composition comprises bleach.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.01 to about 10%, preferably from about 0.1 to about 5% and more preferably from about 1 to about 4% by weight of the total composition. If the composition comprises bleach activator then the bleach activator is preferentially placed in the second composition.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst. Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Bleach catalyst are included in the compositions of the invention are in a preferred level of from about 0.001 to about 10%, preferably from about 0.05 to about 2% by weight of the total composition.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Surfactants may be present in amounts from 0 to 15% by weight, preferably from 0.1% to 10%, and most preferably from 0.25% to 8% by weight of the total composition.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, 5130A, Y167A, R1705, A194P, V2051 and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+5130A
(ii) S101M+G118V+S128L+P129Q+5130A
(iii) N76D+N87R+G118R+S128L+P129Q+5130A+S188D+N248R
(iv) N76D+N87R+G118R+S128L+P129Q+5130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from about 0.1 to about 10, more preferably from about 0.5 to about 5 and especially from about 1 to about 4 mg of active protease per grams of product.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093,562), especially those comprising one or more of the following mutations M202, M208, 5255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

Preferably, the product of the invention comprises at least 0.01 mg of active amylase per gram of composition, preferably from about 0.05 to about 10, more preferably from about 0.1 to about 6, especially from about 0.2 to about 4 mg of amylase per gram of composition.

Preferably, the protease and/or amylase of the product of the invention are in the form of granulates, the granulates comprise less than 29% of efflorescent material by weight of the granulate or the efflorescent material and the active enzyme (protease and/or amylase) are in a weight ratio of less than 4:1.

Performance Polymer

The cleaning composition of the invention can comprises a performance polymer in addition to the homo- or copolymer of (meth)acrylic acid (B), if present, the performance polymer is used in any suitable amount from about 0.1% to about 30%, preferably from 0.5% to about 20%, more preferably from 1% to 15% by weight of the composition. Sulfonated/carboxylated polymers are particularly suitable for the composition of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Dow; Goodrich K-798, K-775 and K-797 supplied by BF Goodrich; and ACP 1042 supplied by ISP technologies Inc. Particularly preferred polymers are Acusol 587G and Acusol 588G supplied by Dow.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and specially from 0.3 to 3% by weight of the composition of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and especially from 0.3 to 3% by weight of the composition of a glass care agent, preferably the glass care agent is a zinc salt.

### Multi-Compartment Pouch

A multi-compartment pouch is formed by a plurality of water-soluble enveloping materials which form a plurality of compartments. The enveloping materials can have the same or different solubility profiles to allow controlled release of different ingredients. Preferably the enveloping material is a water-soluble polyvinyl alcohol film.

Preferred pouches comprise superposed compartments. This disposition contributes to the compactness, robustness and strength of the pouch, additionally, it minimise the amount of water-soluble material required. The robustness of the pouch allows also for the use of very thin films without compromising the physical integrity of the pouch. The pouch is also very easy to use because the compartments do not need to be folded to be used in machine dispensers of fix geometry. It is crucial in the case of multi-compartment pouches comprising liquid and solid compositions in different compartments that the liquid compositions have a low equilibrium relative humidity. The liquid composition of the pouch of the invention is extremely suitable for multi-compartment pouches comprising a solid composition.

Preferably, the second compartment contains a solid composition, more preferably in powder form. The solid and the liquid compositions are preferably in a weight ratio of from about 5:1 to about 1:5, more preferably from about 3:1 to about 1:2 and even more preferably from about 2:1 to about 1:1. This kind of pouch is very versatile because it can accommodate compositions having a broad spectrum of values of solid:liquid ratio.

For dispenser fit reasons, especially in an automatic dishwasher, the pouches herein have a square or rectangular base and a height of from about 1 to about 5 cm, more preferably from about 1 to about 4 cm. Preferably the weight of the solid composition is from about 5 to about 20 grams, more preferably from about 10 to about 18 grams and the weight of the liquid compositions is from about 0.5 to about 10 grams, more preferably from about 1 to about 8 grams.

The enveloping materials which form different compartments can have different solubility, under the same conditions, releasing the content of the compositions which they partially or totally envelope at different times.

Controlled release of the ingredients of a multi-compartment pouch can be achieved by modifying the thickness and/or the solubility of the enveloping material. The solubility of the enveloping material can be delayed by for example cross-linking the film as described in WO 02/102,955 at pages 17 and 18. Other enveloping materials, in particular water-soluble films designed for rinse release are described in U.S. Pat. No. 4,765,916 and U.S. Pat. No. 4,972,017. Waxy coating (see WO 95/29982) of films can help with rinse release. pH controlled release means are described in WO 04/111178, in particular amino-acetylated polysaccharide having selective degree of acetylation.

Other means of obtaining delayed release by multi-compartment pouches with different compartments, where the compartments are made of films having different solubility are taught in WO 02/08380.

### EXAMPLES

Percentages refer to % by weight unless expressly noted otherwise.

The following substances were used:

Complexing agent A.1: Trisodium salt of MGDA, provided as 40% by weight aqueous solution, pH value: 13.

Polymer B.1: Homopolymer of acrylic acid, powder, 92% purity, neutralized with sodium hydroxide, weight average molar weight as determined by GPC is 4000 g/mol, the pH of a 1 weight % aqueous solution is 8.

Comparative polymer B.2: Polycondensate of naphthalenesulfonic acid, powder, 95% purity, Na salt, the pH of a 1 weight-% aqueous solution is 10.

Formic acid, 100% active.

### Example 1

112.5 g complexing agent A.1 (40 wt % solution), 8.15 g polymer B.1 and 1.6 g formic acid were mixed at 23° C., a clear solution was obtained. 22.25 g of water was removed by distillation under vacuum.

The aqueous solution so obtained was clear. It had a dynamic viscosity of 345 mPas (measured with a Brookfield viscometer at 23° C., using spindle 31) and was stable in a sealed glass bottle at 23° C., 60% relative humidity for at least 5 weeks.

### Comparative Example 1

Example 1 was repeated, replacing polymer B.1 by comparative polymer B.2. The resulting solution turned opaque within 12 hours.

### Comparative Example 2

112.5 g complexing agent A.1 (40 wt % solution), 16.30 g polymer B.1 and 1.6 g formic acid were mixed at 23° C. 30.4 g of water was removed by distillation under vacuum.

The aqueous solution so obtained was instantaneously turbid.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A single or multi-phase water-soluble cleaning pouch comprising a cleaning composition and an enveloping material, the pouch comprising at least one compartment comprising an aqueous composition, the aqueous composition comprising
(i) in the range of from about 45 percent by weight to about 60 percent by weight based on the total weight of the aqueous composition of at least one complexing agent (A) selected from the group consisting of methylglycine diacetic acid, glutamic acid diacetic acid, their salts and mixtures thereof;
(ii) in the range of from about 1 percent by weight to about 30 percent by weight based on the weight of component (A) of at least one homo- or copolymer of (meth)acrylic acid (B) that is either partially or fully neutralized, and
(iii) water.

2. A pouch according to claim 1 wherein the aqueous composition comprises about 10% or more of water by weight of the composition.

3. A pouch according to claim 1 wherein the enveloping material surrounding the liquid composition is cold-water insoluble and warm-water soluble.

4. A pouch according to claim 1, wherein the complexing agent (A) is a mixture of L- and D-enantiomers of methyl glycine diacetic acid and its salts, said mixture containing predominantely the respective L-isomer with an enantiomeric excess (ee) in the range of from about 10 to about 75 percent.

5. A pouch according to claim 1 wherein the complexing agent (A) is essentially L-glutamic acid diacetic acid that is at least partially neutralized with alkali metal.

6. A pouch according to claim 1 wherein the content of complexing agent (A) in the aqueous composition is in the range of from about 45 to about 55 percent by weight.

7. A pouch according to claim 1 wherein the content of the homo- or copoymer of (meth)acrylic acid (B) in the aqueous composition is in the range of from about 2.5 percent by weight to about 20 percent by weight based on the weight of component (A).

8. A pouch according to claim 1 wherein about 10 to about 100 mol-% of the carboxylic groups of the homo- or copolymer of (meth)acrylic acid are neutralized with alkali metal.

9. A pouch according to claim 1 wherein the homo- or copolymer of (meth) acrylic acid (B) has an average weight molecular weight of from about 1500 to about 15000 g/mol.

10. A pouch according to claim 1 wherein the aqueous composition comprises an organic acid salt (C) in the range of from about 0.5 to about 15% by weight.

11. A pouch according to claim 1 wherein the aqueous composition comprises an organic acid salt (C) partially neutralized or fully neutralized with alkali metal wherein the salt is selected from the group consisting of citric acid, formic acid, and acetic acid.

12. A pouch according to claim 1 further comprising a second compartment containing a second composition comprising a moisture sensitive ingredient wherein the moisture sensitive ingredient is preferably selected from the group consisting of bleach, enzymes and mixtures thereof.

13. A pouch according to claim 1 wherein the aqueous composition has an eRH of about 65% or less at 20° C.

14. A pouch according to claim 1 wherein the cleaning composition is an automatic dishwashing detergent.

15. A process for making a single or multi-phase water-soluble cleaning pouch according to claim 1, comprising the steps of
(i) providing an aqueous solution of complexing agent (A) with a solids content in the range of from about 41 to about 50 percent weight,
(ii) adding homo- or copolymer of (meth)acrylic acid (B) to said solution, followed by
(iii) removal of water to obtain an aqueous composition with a concentration of complexing agent (A) in the respective aqueous solution of from about 45 to about 60%; and
(iv) making a first open compartment;
(v) filling the open compartment with the aqueous composition resulting from step (iii); and
(vi) closing the open compartment.
